(19) United States
(12) Patent Application Publication
(10) Pub. No.: US 2007/0201829 A1
(43) Pub. Date: Aug. 30, 2007

(54) System and method of providing advertisements during DVD playback

(76) Inventors: Atul D. Patel, Austin, TX (US); Herman Rodriguez, Austin, TX (US)

Correspondence Address: IBM CORPORATION (VE);C/O VOLEL EMILE, P. O. BOX 162485, AUSTIN, TX, 78716, US

(21) Appl. No.: 11/358,752

(22) Filed: Feb. 21, 2006

(51) Int. Cl. H04N 7/00

(52) U.S. Cl. 386/95

(57) ABSTRACT

A method wherein contents of DVDs may be restricted based upon purchased certificates is provided. The certificates allow for secured information on playback. Specifically, whenever a DVD is to be played, a certificate is consulted to determine whether the content of the DVD should be played with or without commercial interruptions. If the certificates provide for commercial interruptions, then commercials can be obtained from an online service that renders commercials on demand, or from the DVD itself. In such a case, the content of the DVD may be interspersed with commercials.

### BACKGROUND OF THE INVENTION

1. Technical Field

The present invention is directed generally to digital video or versatile disk (DVD). More specifically, the present invention is directed to a system and method of providing advertising during DVD playback.

2. Description of Related Art

Commercial enterprises spend millions of dollars each year to promote brand recognition, tout benefits and features of their products, market promotional offers to consumers etc. on television. This makes television advertising just in the U.S.A., for instance, a multi-billion dollar industry.

With the advent of cable television (cable TV), a new form of advertising (i.e., addressable advertising) has emerged. Addressable advertising is the ability to deliver customized advertisements to individual set-top boxes within a household based on specific knowledge about that household (e.g., income, ethnicity, presence of children, purchase habits, etc.). This enables operators of cable broadcast systems to increase advertising revenues by charging advertisers a higher “per-viewer” rate in order to reach a particular (i.e., target) audience.

Typically, an addressable advertising system uses a set-top box in a viewer's home to switch original advertisements with customized ones. For example, when a viewer is watching cable TV, the set-top box is tuned to a channel (selected by the viewer) and transmits a regular broadcast television signal provided by a cable company to the television set. When a commercial break is to occur in the regular broadcast television signal, the cable company transmits a “switch” signal to the set-top box that causes the set-top box to tune to another channel in which audience-specific commercial advertisements are broadcast. After a certain number of targeted commercials are played on the viewer's television set, a second “switch” signal is sent to the set-top box to make it tune back to the regular broadcast television signal.

The set-top box (or any other device) may be used to monitor viewing habits of viewers. The viewer information gathered in this manner is transmitted back to the broadcaster in order to allow for data mining. The information collected is typically remote control data indicating viewer channel selections and time stamps indicating the time spent viewing each channel. The gathered data may then be sold to advertisers that may use it to improve target advertisements.

DVD programs (e.g., movies on DVDs), however, do not allow for advertising. According to the Digital Entertainment Group (DEG), DVD sales (films, television series, special interests, etc.) totaled more than $15 billion in 2004. Thus, DVDs may be a great source of advertising revenues that are not being tapped. Further, revenues from DVD advertising may contribute to the reduction in cost of the DVDs.

Thus, what is needed is a system and method of providing advertising during DVD playback.

### SUMMARY OF THE INVENTION

The present invention provides a DVD player for, computer program product for, and method of, playing back contents of DVD with commercial interruptions. When a DVD is to be played, a certificate is consulted to determine whether the content of the DVD should be played with or without commercial interruptions. If the certificates provide for commercial interruptions, then commercials can be obtained from an online service that renders commercials on demand, or from a storage device in the DVD player or from the DVD itself. In the case where commercials are obtained from the DVD itself, the commercials may be interspersed with the content or programming on the DVD.

Further, DVDs that play back with commercial interruptions may be bought at a lower price than those that do not. In addition, if a user decides to update to a no-commercial-interruptions DVD, the user may do so without having to obtain a new disk. In such a case, an updated certificate may be downloaded to the user's DVD player or Internet Protocol Television (IP TV) or any device (i.e., digital video recorder (DVR), TiVo etc.) or entered in the DVD player by the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a television set (TV) connected to an exemplary DVD player in accordance with the present invention.

FIG. 2 illustrates a block diagram of a DVD player in accordance with the invention.

FIG. 3 contains a table having two columns into which DVD IDs are cross-referenced with purchase certificates.

FIG. 4a is a flow chart of a first process that may be used by the invention.

FIG. 4b is a process that may be used when a DVD is to be played back.

FIG. 4c is a process that may be used during a DVD playback.

### DETAILED DESCRIPTION OF THE PREFERRED EMBODIMENT

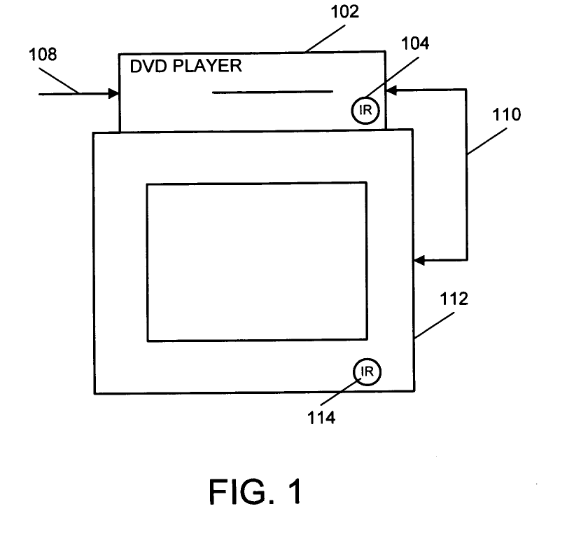

Turning to the figures, FIG. 1 illustrates a television set (TV) 112 connected to an exemplary DVD player 102 in accordance with the present invention. As shown in the figure, DVD player 102 may be in communication with an on-line service provider through connection line 108. Obviously, the connection to the service provider may be via Internet, public switched telephone network (PSTN), cable, satellite, conventional radio frequency (FR) antenna etc. Therefore, the signal on connection line 108 may be digital (including IP packets) or analog.

The DVD player 102 is also connected to the TV 112 via connection line 110. The DVD player 102 includes infrared (IR) sensor 104 that receives commands such as “play”, “fast forward” (FFW), “rewind” (RW), “menu” etc. from a remote control device operated by a viewer. Likewise, TV 112 contains an IR sensor 114 that receives commands (such as channel up, channel down, volume up, volume down, power ON/OFF etc.) from a remote control device operated by the viewer. The viewing habits of the viewer as indicated by when the TV 112 is turned on/off, channels tuned in (in the case where the TV 112 receives signals without a decoder set-top box) etc. may be sent to the service provider through DVD 112 for data mining purposes.

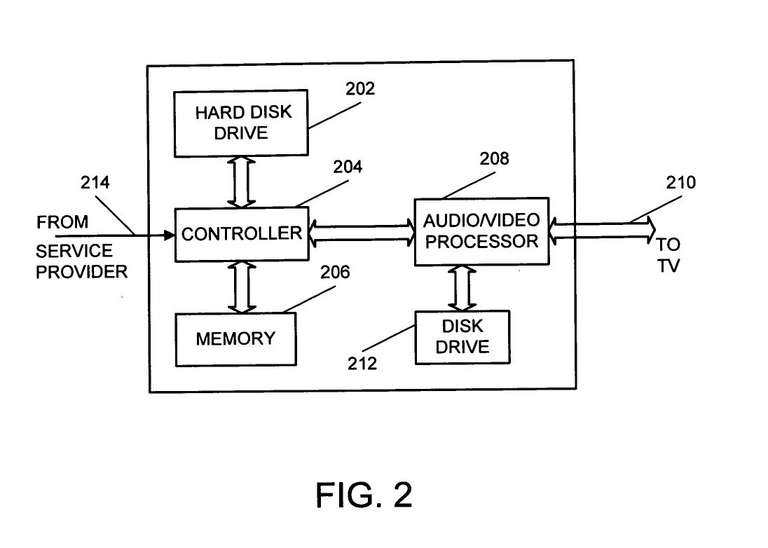

FIG. 2 illustrates a block diagram of a DVD player in accordance with the invention. The DVD player includes a hard disk drive 202 in a two-way communication link with a controller 204. The controller 204 is in a two-way communication link with an audio/video processor 208 and memory 206. Further, audio/video controller 208 is in a two-way communication link with disk drive 212. Note that for simplicity reasons only components needed to explain the invention are shown in FIG. 2. Thus, the components should not be taken as being all inclusive of a DVD player or limited by the illustrated components.

The controller 204 may request and receive data from a service provider over connection line 214. The data may represent certificates, advertisements, software programs (e.g., operating system (OS) and application programs) and updates thereof etc. The controller 204 generally stores the certificates, advertisements, software programs and updates on a disk in hard disk drive 202. When the DVD player is turned on, the controller 204 loads the OS and any needed application programs into memory 206. Users insert DVDs into disk drive 212 for playback.

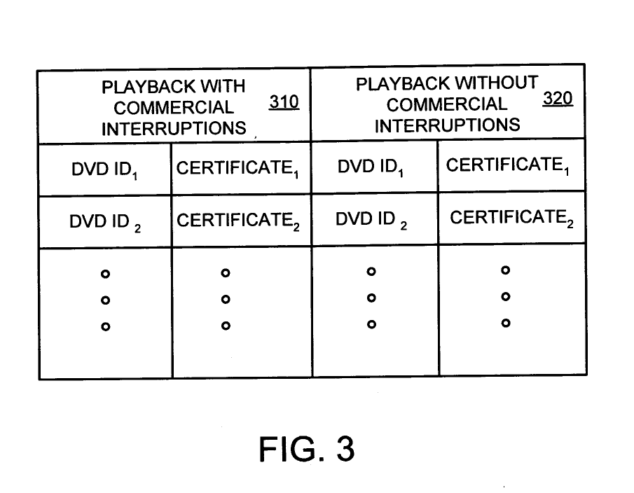

Each DVD may contain an identification (i.e., a DVD ID). The DVD ID is used to find the certificate with which the DVD is associated. For example, when a DVD is inserted into disk drive 212, the audio/video processor 208 reads data and processes the data and outputs audio and video signals to the TV to which the DVD player is connected along communication line 210. However, before audio/video controller 208 transmits the audio and video signals to the TV, the audio/video controller 208 passes to controller 204 the DVD ID. Using the DVD ID, the controller 204 may locate or retrieve the certificate with which the DVD is associated from the disk in hard disk drive 202. If the DVD ID is not on the disk, then the DVD has not yet been played on the DVD player. Consequently, the user may be prompted to enter the certificate. Alternatively, the DVD player may obtain the certificate directly from the service provider using the DVD ID. In any case, once the controller 204 obtains the certificate, the controller 204 will cross-reference it with the DVD ID and store the result into a table as shown in FIG. 3.

FIG. 3 contains a table having two main columns into which DVD IDs are cross-referenced with purchase certificates. One column (column 310) is used to cross-reference DVD IDs with certificates that allow for DVD playback with commercial interruptions. The other column (column 320) is used to cross-reference DVD IDs with certificates that do not allow for DVD playback with commercial interruptions.

Generally, a list of certificates that allow for commercial interruptions as well as one of those that do not allow for commercial interruptions may be downloaded in advance from the service provider over line 214 and stored. When a user enters a certificate or when the controller downloads a certificate from the service provider, the two lists of certificates previously downloaded from the service provider are consulted to determine whether or not the certificate is one that allows for commercial interruptions. If the certificate allows for commercial interruptions, it, along with the cross-referenced DVD ID, is entered in column 310. If, on the other hand, the certificate does not allow for commercial interruptions, it and its cross-referenced DVD ID will be entered in column 320.

When and if the user updates to a non-commercial-interruptions DVD, the user will be given a new certificate (i.e., a certificate that does not allow for commercial interruptions). The user may insert the DVD in disk drive 212 and, using the remote control, access an option that allows the user to enter the new certificate into the DVD player. Upon receiving the new certificate, the controller 204 will search the table to see whether the DVD ID has already been cross-referenced with a certificate (that allows for commercial interruptions) in the table. If so, the controller will erase the DVD ID from that column (i.e., column 310) and cross-referenced the DVD ID with the new certificate in the other column (i.e., column 320). If the DVD ID is not already cross-referenced with a certificate, the controller will do so and store the result in column 320.

If the certificate allows for DVD playback with commercial interruptions, then periodically the playback of the DVD will be interrupted with commercial advertisements. Note that certain DVD player control operations such as the fast forward, skip, and rewind (FFW/NEXT/RW), of the DVD player may be inoperative during the commercials.

Note further that if the certificate entered by the user is not in the list of certificates that do not allow for commercial interruptions previously downloaded from the service provider, the DVD will be played back with commercial interruptions. Further, if the certificate is not any one of the two lists, the DVD may not be played at all. This may reduce the number of DVD movies that are pirated.

The onset of a commercial interruption may be based on a signal embedded in the recording on the DVD. The end of a commercial interruption may also be based on a signal. But, this signal may be from controller 204. Further, for every onset of commercial interruption signal on a DVD, there is a resumption signal.

In operation, when the commercial interruption onset signal is encountered, the audio/video processor 208 stops reading data from the DVD in disk drive 212 and requests that controller 204 forward data representing the commercials. When controller 204 determines that it should end a commercial interruption (this may be time-based or algorithm based), the controller may insert a signal into the data being passed to audio/video processor 208. Upon receiving the signal, the audio/video processor 208 may resume reading data from the DVD at the point where the resumption signal (that accompanies that particular onset of a commercial interruption signal) is embedded in the data on the DVD.

The controller 204 may determine which commercials to provide (as well as how frequent to provide a commercial) to the audio/video processor 208 based on an algorithm or from commands received from the service provider over line 214. As mentioned before, the service provider may provide the commercials that are stored on the disk in hard disk drive 202 in real-time or ahead of time. The commercials may be commercials targeted for that particular household based on data collected from that household (i.e., ethnicity, viewing habits, income etc.). Furthermore, the frequency of the commercials or the content of the commercials may be targeted based on a graduated fee schedule, such that for the payment of a higher fee, less commercial interruptions are presented, or the content of the commercials may be commensurate to the paid fee. The certificate may contain information to identify any paid fee.

If the certificate does not allow for DVD playback with commercial interruptions, then the playback of the DVD will not be interrupted with commercial advertisements. That is, when the DVD is inserted into disk drive 212, the DVD ID is read to controller 204 by audio/video processor 208. The controller 204 consults the table to determine whether the certificate to which the DVD ID is cross-referenced allows for commercial interruptions. If not, the controller 204 provides the end of commercial interruption signal as soon as it receives a request from the audio/video processor 208 for commercials.

In cases where commercial interruptions are interspersed in the DVD itself, the DVD may have a specific DVD ID. Each commercial interruption onset signal is inserted just before a commercial interruption is to occur and each resumption signal is inserted where a commercial interruption ends. The specific DVD ID, when not cross-referenced with a certificate in the table in FIG. 3 instructs the audio/video processor 208 to ignore the commercial interruption onset signal. Therefore, the DVD will playback with commercial interruptions.

When and if the user upgrades to a non-commercial interruptions certificate, the user will have to enter the certificate into the DVD player. The certificate and the special DVD ID is cross-referenced in column 320 in FIG. 3. Then, as described above, upon encountering the onset of a commercial interruption signal, the audio/video processor 208 requests that the controller 204 provide the commercials. However, since the certificate and specific DVD ID are cross-referenced in column 320, the controller 204 provides the end of commercial interruption signal as soon as it receives a request for commercials from the audio/video processor 208.

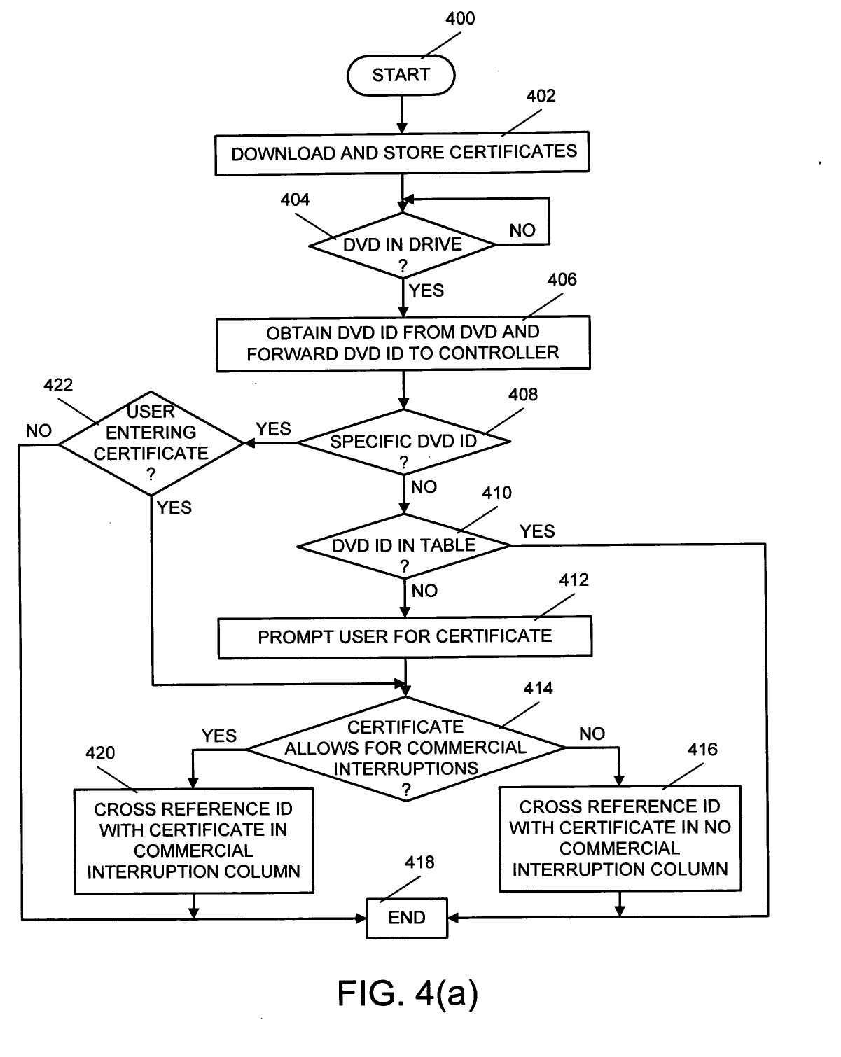

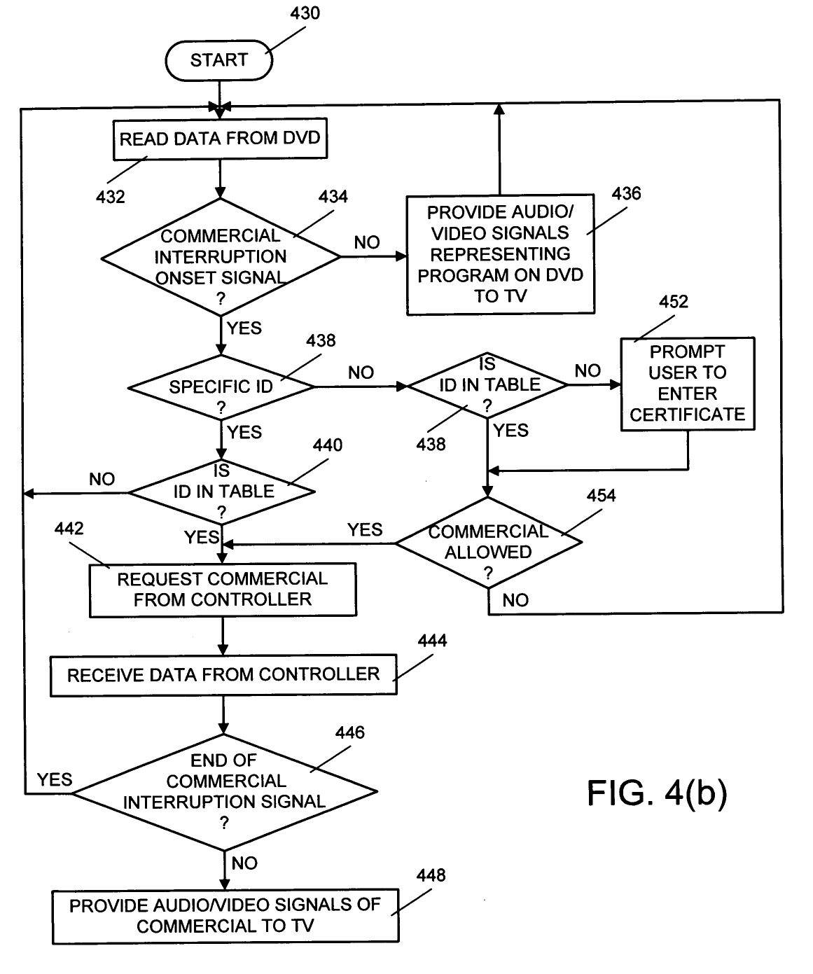

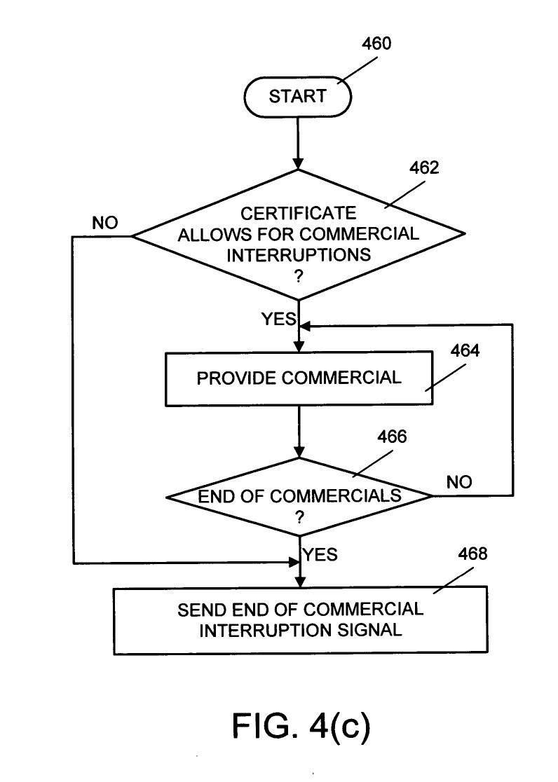

FIG. 4a is a flow chart of a first process that may be used by the invention. The process starts the first time a DVD player is turned on while connected to a service provider (step 400). At that point the controller 204 downloads and stores all the certificates (both the ones that allow for commercial interruptions and the ones that do not) from the service provider (step 402). A check may be made to determine whether a DVD is in the drive 212 (step 404). If a DVD is in the drive 212, the audio/video processor 208 obtains the DVD ID from the DVD and forwards it to controller 204 (step 406). At that point, it will be determined whether the DVD ID is a specific ID (step 408). If it is not a specific ID, another check is done to determine whether the ID is already in the table in FIG. 3 (step 410). If the DVD ID is already in the table, then the process ends (step 418).

If the ID is not already in the table, the user will be prompted to enter the purchase certificate (step 412). After the certificate has been entered, it will be determined whether or not it is a certificate that allows for commercial interruptions (step 414). Depending on the result, the certificate will be cross-referenced with the ID in the proper column of the table in FIG. 3 (steps 420 and 416) before the process ends (step 418).

If the ID is a specific ID, it is determined whether the user is entering a certificate (step 422). If so, the process jumps to step 414. If not, the process ends (step 418).

FIG. 4b is a process that may be used by audio/video processor 208 when a DVD is to be played back. The process starts when the user presses “play” (step 430). At that point, the processor 208 starts reading data from the DVD (step 432). A check is made to determine whether the data read is a commercial interruption signal (step 434). If it is not a commercial interruption signal, the data is converted into audio/video signals and provided to the TV (step 436) before the process jumps back to step 432 where more data will be read from the DVD.

If the data read is a commercial interruption signal, another check is made to determine whether the DVD ID of the DVD is a specific ID (step 438). If the ID is specific, a check is made to determine whether the ID is in column 320 in the table of FIG. 3 (step 440). If the ID is in column 320, the processor 208 requests a commercial from the controller 204 (step 442). The controller 204 provides the data representing the commercial to the processor 208 which upon receiving the data (step 444) checks it to determine whether it is an “end of commercial interruption signal” (step 446). If the data is an “end of commercial interruption signal” (which in this case it will be) the process jumps back to step 432. If the data is not an “end of commercial interruption signal”, the processor 208 will process it and forwards audio/video signals to the TV (step 448) before the process jumps back to step 442 to request another commercial.

If the DVD ID is specific but not in the table (see step 440), then the process will jump back to step 432 in order for the audio/video processor 208 to read more data from the DVD. Note that this will happen when there are commercials interspersed on the DVD and the user has not upgraded to a non-commercial-interruption certificate. Note further that the data read in this case will be advertising data.

If the DVD ID is not a specific ID (see step 438), then a check will be made to determine whether or not the ID is in the table in FIG. 3 (step 450). If the ID is in the table, then it will be determined if commercials are allowed by inspecting the columns in the table (step 454). If commercials are allowed as determined based on the inspection, the process will jump to step 442 where the audio/video processor 208 will request commercials from the controller 204. If commercials are not allowed, the process will jump back to step 432 in order for the audio/video processor 208 to read more data from the DVD. If the ID is not in the table, the user will be prompted to enter the purchase certificate (step 452) and the process will jump to step 454.

FIG. 4c is a process that may be used by controller 204 during a DVD playback. The process starts when the controller receives a request for commercials from audio/video processor 208 (step 460). At that point a check will be made to determine whether or not the certificate with which the DVD ID is cross-referenced allows for commercial interruptions (step 462). If commercials are allowed, the controller 204 will provide the commercials to the audio/video processor 208 by repeatedly going through steps 464 and 466. When the controller determines that DVD playback should resume (step 466), it will send an end of commercial interruption signal to the audio/video processor 208 (step 468). If the certificate does not allow for commercial interruptions, process will jump to step 468 where the controller 204 will immediately send an end of commercial interruption signal to the audio/video processor 208 upon receiving the request for commercials.

Note that one particular embodiment of the invention is provided above. However, there may be other embodiments. For example, the playback of the DVD with commercial interruptions may be tiered. That is, the cost of the DVD may determine whether the DVD will play back with commercial interruptions, with reduced commercial interruptions or with no commercial interruptions.

When commercials are embedded in a DVD, the commercials may be refreshed by connecting with the service provider at the point the commercials are programmed to play. This will allow a DVD player to play existing (i.e., embedded) commercials if there is not an available connection to the service provider. It also allows new or different commercials to be played when the DVD player is connected to the service provider.

Further, the commercials may be tailored to the subject matter of the DVD. Moreover, different commercials may be played at different frequencies. The frequency at which a commercial is played may be based on the viewing habits of the viewer, which may include the number of times the subject DVD is played with or without suspension of playback.

In addition, the commercials may be tailored to the subject matter of the DVD and the time the DVD is played. Moreover, different commercials may be played at different times of the day. The time of day at which a commercial is played may be based on the viewing time of the DVD, which may include viewing a commercial when playing the DVD during daylight hours, and playing the DVD without commercials during certain days and times such as late nights and holidays.

Furthermore, the invention can take the form of a computer program product accessible from a computer-usable or computer-readable medium providing program code for use by or in connection with a computer or any other instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and Digital Video/Versatile Disk (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing a commercial advertising during playback of contents on digital versatile disk (DVD playback) by a DVD player comprising the steps of:
providing a purchase certificate for indicating whether or not a DVD playback should be interrupted with a commercial advertising; and
periodically interrupting the DVD playback with a commercial advertising if the certificate indicates that the DVD playback is to be interrupted with a commercial advertising.

2. The method of claim 1 wherein the commercial advertising includes customized advertisements based on viewing habits of a viewer.

3. The method of claim 2 wherein the viewing habits of the viewer are collected by a service provider.

4. The method of claim 2 wherein the customized advertisements are pre-stored on the DVD player.

5. The method of claim 2 wherein the customized advertisements are downloaded and presented to the viewer in real time.

6. The method of claim 1 wherein the commercial advertising is interspersed within a content of a DVD.

7. The method of claim 1 wherein if the certificate indicates that the DVD playback is to be interrupted with a commercial advertising a user may upgrade to a certificate indicates that the DVD playback is not to be interrupted with a commercial advertising.

8. A computer program product on a computer readable medium for providing a commercial advertising during playback of contents on digital versatile disk (DVD playback) by a DVD player comprising:
code means for obtaining a purchase certificate for indicating whether or not a DVD playback should be interrupted with a commercial advertising; and
code means for periodically interrupting the DVD playback with a commercial advertising if the certificate indicates that the DVD playback is to be interrupted with a commercial advertising.

9. The computer program product of claim 8 wherein the commercial advertising includes customized advertisements based on viewing habits of a viewer.

10. The computer program product of claim 9 wherein the viewing habits of the viewer are collected by a service provider.

11. The computer program product of claim 9 wherein the customized advertisements are pre-stored on the DVD player.

12. The computer program product of claim 9 wherein the customized advertisements are downloaded and presented to the viewer in real time.

13. The computer program product of claim 8 wherein the commercial advertising is interspersed within a content of a DVD.

14. The computer program product of claim 8 wherein if the certificate indicates that the DVD playback is to be interrupted with a commercial advertising a user may upgrade to a certificate indicates that the DVD playback is not to be interrupted with a commercial advertising.

15. A digital versatile disk (DVD) player for providing a commercial advertising during playback of contents on a DVD (DVD playback) comprising:
at least one storage device for storing code data; and
at least one processor for processing the code data to obtain a purchase certificate for indicating whether or not a DVD playback should be interrupted with a commercial advertising, and to periodically interrupt the DVD playback with a commercial advertising if the certificate indicates that the DVD playback is to be interrupted with a commercial advertising.

16. The DVD player of claim 15 wherein the commercial advertising includes customized advertisements based on viewing habits of a viewer.

17. The DVD player of claim 16 wherein the viewing habits of the viewer are collected by a service provider.

18. The DVD player of claim 16 wherein the customized advertisements are pre-stored therein.

19. The DVD player of claim 16 wherein the customized advertisements are downloaded and presented to the viewer in real time.

20. The DVD player of claim 15 wherein the commercial advertising is interspersed within a content of a DVD.
